(19) United States
(12) Patent Application Publication
(10) Pub. No.: US 2021/0271262 A1
(43) Pub. Date: Sep. 2, 2021

(54) Autonomous Mobile Robot And Method For Controlling An Autonomous Mobile Robot

(71) Applicant: RobArt GmbH, Linz (AT)

(72) Inventors: Vladimir ALEXANDROV, Linz (AT); Erwin MASCHER, Linz (AT); Harold ARTES, Linz (AT)

(73) Assignee: RobArt GmbH, Linz (AT)

(21) Appl. No.: 17/254,284

(22) PCT Filed: Jun. 5, 2019
(86) PCT No.: PCT/AT2019/060186

§ 371 Date: Dec. 20, 2020

(30) Foreign Application Priority Data
Jun. 20, 2018 (DE) 10 2018 114 892.5

(51) Int. Cl. G05D 1/02; G05D 1/00

(52) U.S. Cl. CPC G05D 1/0274; G05D 1/0238; G05D 2201/0203; G05D 1/0272; G05D 1/0055

(57) ABSTRACT

An autonomous mobile robot, comprising: a drive unit which is designed to receive control signals and to move the robot in accordance with the control signals, a navigation sensor for capturing navigation features, and a navigation unit coupled to the navigation sensor. The navigation unit is designed to receive information from the navigation sensor and to plan a movement for the robot. The robot also has a control unit, which is designed to receive movement information representing the movement planned by the navigation unit and to generate the control signals based on the movement information. The robot has further sensors which are coupled to the control unit such that the control unit can receive further sensor information from the further sensors. The control unit is designed to pre-process this further sensor information and to supply the pre-processed sensor information in a pre-defined format to the navigation unit.

### TECHNICAL AREA

The exemplary embodiments described herein relate to an autonomous mobile service robot such as, for example, a robot for processing a surface (e.g. cleaning floors), for transporting objects, or for monitoring and inspecting an area, as well as a method for controlling such an autonomous mobile robot.

### BACKGROUND

In recent years, autonomous mobile robots have been used with increasing frequency in private households as well as in the business environment. For example, autonomous mobile robots can be used to clean surface areas, to monitor buildings, to enable communication independently of location and activity, or to transport objects.

In this case, robots and systems are increasingly being used which create a map of the environment for targeted navigation using a SLAM algorithm (Simultaneous Localization and Mapping, see, e.g., B. H. Durrant-Whyte and T Bailey: “Simultaneous Localization and Mapping (SLAM): Part I The Essential Algorithms,” in: IEEE Robotics and Automation Magazine, vol. 13, No. 2, pg. 99-110, June 2006). The algorithms used to regulate and control the robot in this case may be highly optimized with respect to the sensors and actuators used and the specific form of the robot. This has the disadvantage that the reuse of the implemented software is only possible with extensive adaptation developments. In an alternative approach, various abstraction levels are incorporated into the software in order to support the most varied of hardware configurations. These solutions are often computationally intensive and thus require expensive hardware.

With the goal of developing and marketing systems with ever-increasing intelligence, the complexity of the behavioral routines used in the autonomous mobile robots also continually increases. However, increasing complexity is usually associated with an increased susceptibility to errors, as with many complex software applications. This means that the while the robot may have sensors to detect a hazardous situation, the navigation and control software does not react appropriately to the detected hazard situation, for example, due to faults, undetected programming errors, or undesired influence from outside. Verification as to whether a robot is reacting appropriately and correctly in all conceivable hazardous situations is associated with significant effort as the complexity of the navigation and control software increases. Such a verification of the functional safety may be required in certain applications due to statutory provisions. The requirements placed on the functional safety is also the subject matter of various standards (e.g. EN/IEC 61508 and EN/IEC 62061).

The object upon which the invention is based can consequently be considered, among other things, to provide an autonomous mobile robot with an economical, reusable navigation solution and a robust safety mechanism, and a corresponding control process for an autonomous mobile robot.

### SUMMARY

The aforementioned object is achieved by means of an autonomous mobile robot according to claim 1 as well as by means of a method according to claim 12. Various exemplary embodiments and refinements are the subject matter of the dependent claims.

An autonomous mobile robot is described in the following. According to one exemplary embodiment, the robot has a drive unit, which is designed to receive control signals and to move the robot in accordance with the control signals, a navigation sensor for capturing navigation features, and a navigation unit coupled to the navigation sensor. To this end, the navigation unit is designed to receive information from the navigation sensor and to plan a movement for the robot. The robot further has a control unit, which is designed to receive movement information representing the movement planned by the navigation unit and to generate the control signals based on the movement information. The robot has further sensors, which are coupled to the control unit to the extent that the control unit can receive further sensor information from the further sensors. The control unit is designed to pre-process this further sensor information and to provide the pre-processed sensor information in a pre-defined format to the navigation unit. The planning of the movement for the robot by the navigation unit is based both on the information from the navigation sensor and on the pre-processed sensor information supplied by the control unit. A robot structured in this manner enables a completely functional separation between the navigation unit and the control unit. Furthermore, a corresponding method is described.

### BRIEF DESCRIPTION OF THE FIGURES

The invention is explained in more detail in the following by means of examples shown in the figures. The representations are not necessarily true-to-scale and the invention is not limited to only the shown aspects. Instead, more focus is on showing the underlying principles of the invention.

FIG. 1 illustrates, by means of example, various autonomous mobile robots as well as various possible hazard situations.

FIG. 2 shows, by means of example, an autonomous mobile robot in a block diagram.

FIG. 3 illustrates, in a block diagram, an exemplary configuration of a control unit for an autonomous mobile robot and the interfaces thereof to the navigation module and the motor controller.

FIG. 4 illustrates, by means of example, a top view of a lower side of an autonomous mobile robot.

### MORE DETAILED DESCRIPTION

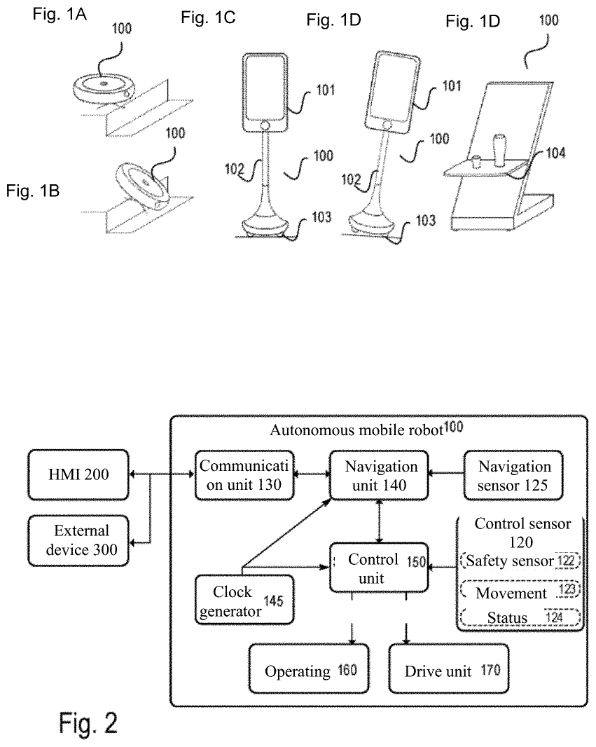

FIG. 1 illustrates various examples of an autonomous mobile robot 100 for the autonomous performing of actions, in which it navigates through its environment as well as potential hazardous situations by means of a map. Actions in terms of the application include the pure navigation of the robot in its environment and comprise, for example, floor processing, floor cleaning, inspection and monitoring actions, transport tasks, or activities in support of a user.

FIG. 1A illustrates, for example, a robotic vacuum cleaner, which is designed to clean, particularly to vacuum, surface areas. The robotic vacuum cleaner in this case usually moves on at least three wheels (in which typically two of these are driven) (not shown in FIG. 1A). In addition, there are usually rotating brushes and/or a suction unit or the like situated on the lower side of the robotic vacuum cleaner for collecting dirt while the robot 100 moves over the surface area. In the event of a crash over a drop-off edge such as, for example, a stairstep, as shown in FIG. 1B, the robotic vacuum cleaner may become damaged. In addition, this may result as well in damage to the surface area, damage to objects situated in the vicinity, or injury to people when the robot 100 falls over or impacts therewith. Thus, some autonomous mobile robots 100 have floor clearance sensors (not shown in FIG. 1), which can detect a drop-off edge such as, for example, a stairstep in a timely manner in order to prevent crashes. Floor clearance sensors are also characterized as floor detection sensors or simply floor sensors.

FIG. 1C shows an example of a telepresence robot. A telepresence robot normally has an interface 101 (also known as a Human-Machine Interface, HMI) such as, for example, a display, smart phone, tablet, or the like. This interface 101 is attached to an upper end of a perpendicular arm 102 of the robot 100. A robot body, which has a drive module 103, is attached to the lower end of the perpendicular arm 102. Due to the narrow shape of the robot 100 as well as the interface 101 attached to the upper end of the perpendicular arm 102, such a telepresence robot has a relatively high center of gravity. Essentially, the robot balances itself. For example, the robot 100 tips over easily when moving over greatly inclined surfaces, whereby the unit can become damaged. The robot 100 may also tip over in the event of an excessively strong acceleration or when traveling over thresholds or steps. The surrounding surface area or objects in the vicinity may also be damaged or people can be injured when the robot 100 tips or falls over. A tipping of the telepresence robot is shown by way of example in FIG. 1D. Thus, telepresence robots may have sensors (not shown in FIG. 1), which are designed to determine the position (particularly the incline), the acceleration, and or/or the angular velocity of the robot 100. Telepresence robots may likewise have sensors, for example, which are designed to detect thresholds (e.g. door thresholds) or steps in order to adapt the movement behavior of the robot accordingly and thus to prevent the robot from tipping over.

FIG. 1E shows, by means of example, an assistance robot, particularly a transport robot. A transport robot usually has a transport platform 104, on which objects to be transported, e.g. plates or glasses, can be placed. On its lower side, the transport robot has wheels, for example, (not shown in FIG. 1E), with which it can move. Such robots 100 can support, for example, elderly persons in everyday activities and enable them, in this manner, to have an independent life. With transport robots, it is essentially important that collisions are prevented to keep the objects to be transported or the entire robot 100 from tipping over and to prevent damage in the environment. To this end, the robot 100 may have the most varied of sensors, which are designed (optionally with corresponding sensor signal processing) to detect stopped or moving objects or people in the environment of the robot 100 (for example with a laser rangefinder, optical triangulation sensors, cameras, etc.).

Thus, it is essentially possible to move the robot autonomously through its operational area using the most varied of methods and processes, and, in doing so, to detect a potential hazardous situation for autonomous mobile robots 100, and to prevent accidents in that there is an appropriate reaction to a detected hazardous situation (i.e., so that an accident is prevented or at least mitigated). Such robots 100 typically have navigation and control software for controlling the autonomous mobile robot 100. Such navigation and control software, which is executed by a processor in a control module, then becomes ever more complex, however. Due to the increasing complexity of the navigation and control software, the risk of undesirable programming errors increases. Furthermore, an increasing number of autonomous mobile robots 100 have access to the Internet. The robot 100 can be regulated and controlled, for example, even if the user is not in the vicinity of the robot 100. The firmware, particularly the navigation and control software, of the robot 100 can be updated as well via the Internet. For example, software updates can be downloaded automatically or at the request of the user. This functionality is also characterized as Over-the-Air-Programming (OTA programming), OTA Upgrading, or Firmware-Over-the-Air (FOTA).

The connection of an autonomous mobile robot 100 to the Internet may also carry the risk, however, that unauthorized persons will obtain access to the robot 100 (e.g. through so-called hacking, cracking, or jailbreaking of the robot) and influence it such that it no longer reacts correctly in hazardous situations, whereby accidents may result. The entire navigation and control software system may be stored in the robot 100 itself or in a storage medium arranged within the robot. However, it is also possible to store a part of the navigation and control software on external devices, e.g. cloud servers. If parts of the navigation and control software are stored on external devices, then parts of the robot 100 will normally no longer be real-time-capable. There are robots 100 known, in which the navigation and control software uses nondeterministic Monte Carlo methods or methods of machine learning, e.g. deep learning (also called Deep Machine Learning). Randomized algorithms which may yield an incorrect result with a probability bounded from above are characterized as the Monte Carlo algorithms. Monte Carlo algorithms are usually more efficient as compared to the deterministic algorithms. Deep learning normally characterizes a class of optimization methods of artificial neural networks, which have numerous intermediate layers (hidden layers) between the input layer and the output layer and thereby have an extensive internal structure. Cause-effect correlations are not a priori established with both Monte Carlo algorithms as well as machine learning and are thus difficult to verify. Therefore, it is very difficult to verify and guarantee safe function of the robot 100 such that the navigation and control software of the robot 100 reacts correctly and in a timely manner to prevent an accident in any hazardous situation. At the same time, the use of such new robot-control methods is necessary in order to make an autonomous mobile robot 100 more intelligent. An improved “intelligence” of the robot makes it possible for the robot 100 to be more easily integrated into the life of the respective user and into its respective environment.

Thus, it may be important or necessary to enable a verifiably safe robot behavior without limiting, however, the intelligence of the robot 100 while doing so. According to one exemplary embodiment, an autonomous mobile robot 100 has a safety module, which can also be characterized as a risk detection module, in addition to the navigation unit, which safety module executes the movement and task planning with the assistance of the aforementioned navigation software. In the examples described herein, the safety module functions independently of the navigation unit. Essentially, the safety module is designed to monitor the robot behavior independently of the navigation unit and to detect hazardous situations. If the behavior of the robot in a detected hazardous situation is classified as being incorrect, dangerous, or inappropriate, the safety module can introduce suitable countermeasures (safety measures). Countermeasures may include, for example, stopping the robot 100 or changing a direction of travel of the robot 100. This is based on the fact that it is normally easier to determine which movement should not be executed because it is unsafe than to determine the correct movement.

Autonomous mobile robots are increasingly performing service tasks in both the private and business sectors. One of the underlying functions in this case is the creation of a map of the environment by means of suitable sensors and the autonomous navigation with the assistance of said map. An underlying problem of the refinement of the robotics is the strong linkage of the software and algorithms used to the underlying hardware, such as particularly the motors of the drive or other operating units necessary for performing tasks, and sensors installed in the robot. Reuse of the software when designing new robots is made difficult by the aforementioned strong linkage.

There are two known approaches in this case for solving this problem. On the one hand, a mobile platform may be provided which meets all requirements placed on the mobility of a robot. New applications must be placed on this platform, which makes this approach inflexible. Another approach is strong modularization of the software, wherein hardware-dependent and hardware-independent modules are separated. This partly requires strong abstraction of the hardware, which normally has a negative effect on the performance of the system.

In contrast thereto, the approach utilized according to one exemplary embodiment seeks a functional separation between specific hardware and the corresponding algorithms. This can be combined with the previously described separation of the navigation unit and a safety module.

FIG. 2 illustrates, by means of a block diagram, an exemplary structure of an autonomous mobile robot 100, which has several functionally separate units. In general, a unit in this case may be an independent assembly (hardware), a component of software for controlling the robot 100, which executes a desired task in a particular robot's operational area, or a combination of both (e.g. dedicated hardware with connected peripheral components and suitable software and/or firmware).

In the present example, the autonomous mobile robot 100 has a drive unit 170, which may have, for example, electric motors, gearboxes, and wheels. The robot 100 can—theoretically—approach any point within its operational area with the aid of the drive unit 170. Furthermore, the robot 100 may have an operating unit 160 (processing unit), which implements a particular process such as, for example, the cleaning of a surface area or the transporting of objects. The operating unit 160 may be, for example, a cleaning unit for cleaning a surface area (e.g. brush, vacuuming device), a transport platform designed as a tablet which is height-adjustable and/or pivotable, a gripper arm for grasping and transporting objects, etc. In some cases, such as, for example, with a telepresence robot or a surveillance robot, an operating unit 160 is not necessarily required. Thus, a telepresence robot usually has a complex communication unit 130 coupled to a human-machine interface 200 with a multimedia unit consisting of, for example, microphone, camera, and display (cf. FIG. 1, interface 101) in order to enable communication among several people far apart from one another spatially. Another example is a surveillance robot which can detect certain (uncommon) events (e.g. fire, light, unauthorized persons, etc.) on monitoring runs with the aid of specialized sensors (e.g. camera, motion detector, microphone) and can inform, for example, a control center of this accordingly.

Furthermore, the robot 100 may have a communication unit 130 in order to establish a communication link to a human-machine interface 200 (HMI) and/or other external devices 300. For example, the communication link 145 is a direct wireless connection (e.g. Bluetooth), a local wireless network connection (e.g. Wi-Fi or ZigBee), or an Internet connection (e.g. to a cloud service). Examples of a human-machine interface 200 are a Tablet PC, smartphone, smartwatch, computer, or smart TV. In some cases, the human-machine interface 200 may also be directly integrated into the robot 100 and can be operated using inputs and outputs via keys, gestures, and/or speech. The previously mentioned external hardware and software may also be situated, at least partially, in the human-machine interface 200. Examples of external devices 300 are computers and servers, to which calculations and/or data are supplied, external sensors, which provide additional information, or other household devices (e.g. other robots), with which the autonomous mobile robot 100 can work or exchange information. The communication unit 130 can provide, for example, information regarding the autonomous mobile robot 100 (e.g. battery status, current work order, map information, etc.), and instructions (e.g. user commands), for example related to a work order for the autonomous mobile robot 100, can be received.

According to the example shown in FIG. 2, the robot 100 may have a navigation unit 140 and a control unit 150 which are configured such that they exchange information. The control unit 150 in this case receives movement and operating information generated by the navigation unit 140. The movement information includes, for example, planned waypoints, way-segments (e.g. circular arcs), or speed information. Waypoints may be indicated, for example, as relates to the current robot pose (pose designates the position and orientation). For example, the distance traveled and an angle of rotation can be indicated for a way-segment (a distance of zero generates a rotation in place; an angle of rotation of zero generates a straight movement). The translational speed and the angular velocity, which is traveled for a pre-definable time, for example, can be used as the speed information. The navigation unit 140 thus plans a specific movement in advance (e.g. a certain way-segment) and provides this (as movement information) to the control unit 150. To this end, the control unit 150 is configured to generate the control signals for the drive unit 170 from the movement information. These control signals may be any signals which are suitable for actuating the actuators (particularly the motors) of the drive. For example, this can be the number of necessary revolutions of a right and left wheel of a differential drive. Alternatively, the motors can be actuated directly via the change in voltage and/or current strength. In principle, the specific hardware configuration (type and position of the actuators) of the robot must be known in order to generate the control signals from the movement information obtained by the navigation unit 140, while the movement information on a more abstract level is determined extensively independently of the hardware used. Thus, the necessary adaptation developments are limited to the control unit 150 upon a change in the drive unit 160.

Similarly to the movement information, the operating information can be converted into control signals for the operating unit 160. Operating information in this case may describe, for example, whether an operating unit is active and at what capacity. Thus, the operating unit 160 may be a cleaning unit with rotating brushes and a suction unit. The operating information includes whether the cleaning unit is currently active and the strength at which it should work. The control signals generated therefrom directly control, for example, the performance of the motors of the brush and of the suction unit. During the aforementioned planning of the movement and during the configuration and updating of the map of the robot's operational area, the navigation unit 140 uses, among other things, information which is supplied by the navigation sensor 125. Such a navigation sensor 125 may be, for example, a contactless optical sensor (e.g. a triangulation sensor).

In addition, the control unit 150 can collect information from control sensors 120 which capture sensor information specific to the robot. This comprises, for example, safety sensors 122 for capturing safety-critical situations in the direct environment of the robot. The previously mentioned floor clearance sensors for detecting drop-off edges are an example of a safety sensor. Other safety sensors 122 may be tactile sensors (e.g. contact switches) for detecting contact with an obstacle or close-range sensors (e.g. infrared sensors) for detecting obstacles in the direct vicinity of the robot. Unintentional collisions with these obstacles can hereby be detected well before they occur. A further example of control sensors 120 are movement sensors 123, which are used to monitor the movement of the robot 100 specifically controlled by the control module 150, which movement in practice is not exactly identical to the movement planned by the navigation unit 140. This includes, for example, odometers such as, for example, wheel encoders, acceleration sensors, and gyroscopes (for example, combined in an Inertial Measurement Unit (IMU)). A further example of control sensors 120 are position sensors for determining the inclination of the robot 100 and a change thereof. A further example of control sensors 120 are status sensors 124 for detecting the status of parts of the robot. This includes, for example, ammeters and voltmeters with which the power consumption, for example of the drive unit, is determined. Other status sensors may comprise switches such as, for example, wheel-contact switches to determine whether the robot has contact with a surface area, or switches which indicate the presence or absence of components such as a brush or dirt collector.

The measured values of the control sensors 120 are recorded and evaluated by the control unit 150. The events can be forwarded, in standardized form, to the navigation unit 140. This can occur at regular intervals, in periodic intervals, or after a prompt from the navigation unit 140. The type of information depends on the sensor and can be depicted on a sensor model typical for the sensor. For example, the odometry data for a differential drive may describe fractions of a wheel rotation (wheel encoder). The path that the wheel assigned to the encoder has traveled can be determined from this. The distance traveled and the change in orientation result from the combination of both wheels of the differential drive as well as the position thereof. The odometry information forwarded to the navigation module 140 describes the change in the position and orientation of the robot since the last update. For example, a drop-off edge can be determined with a floor clearance sensor, in which numerous measuring principles are possible. The control unit 150 determines whether one of the sensors has detected a drop-off edge from the raw data of the floor clearance sensor. The position of a detected drop-off edge can be sent to the navigation unit 140 in the form of the position of the triggering floor clearance sensor relative to a fixed coordinate system of the robot (e.g. starting from the kinematic center point of the differential drive). Alternatively, a number (ID) assigned to the sensor can be sent to the navigation unit 140. In the navigation unit 140, this number (ID) can be used to determine the position of the triggering floor clearance sensor from previously specified parameters. The corresponding parameters (number and position of the sensor) can be loaded, for example, upon initialization of the navigation unit. Data traffic is hereby reduced, and computations are transferred to a potentially more powerful processor of the navigation unit. The information supplied by the control sensors 120 is thus transferred to the navigation unit 140 in a form which is abstracted and independent of specific sensors.

Further examples of such sensors are tactile sensors for recording contact with obstacles (e.g. collisions). The corresponding information regarding a detected contact can be transferred (similar to the event of a detected drop-off edge) upon a detected event with the position or number (ID) of the triggering sensor. Sensors for preventing collisions can detect obstacles in close range without contact. Infrared sensors, for example, which generate an infrared signal are used for this. A conclusion can be made about the presence and the distance of an obstacle from the reflection thereof. For these sensors, the distance in which there is safely no obstacle is sent to the navigation unit, for example, in addition to the sensor position.

According to the example shown in FIG. 2, the navigation unit 140 further obtains, in addition to the sensor information from the control unit 150, direct sensor measurements of one or more navigation sensors 125, which provide information on the environment of the robot with which the robot can orient itself. This means that the position of navigation features which are suitable for establishing a map can be determined with the sensor(s) 125. Such a navigation sensor 125 is, for example, a sensor for contactless measuring of distances to objects over greater distances such as, particularly, laser distance sensors or 3D cameras, which determine distances by means of triangulation or a runtime measurement. These sensors provide information on the position of obstacles which may be omitted in a map. Additionally or alternatively, the navigation sensor 125 may be a camera which provides images of the environment of the robot. The images can be directly used as navigation features. Alternatively or additionally, characteristic features such as corners and edges can be determined, by means of object detection and image processing, in the environment images, which are used as navigation features. Particularly by means of the combination of the odometry information from the control unit 150 and the navigation features, a map of the environment can be established by means of known SLAM algorithms, and the position of the robot in the map can be determined and used for the navigation and task planning. Such a map can be temporarily (i.e. new with each use) established or stored for repeated use and reloaded as needed. The advantage of the solution is a tight integration of the navigation sensor and the algorithms associated herewith. The combination of the navigation unit 140 and the navigation sensor 125 can hereby be integrated into new robot applications relatively easily. This only requires a control unit 150 with the specified interface for exchanging data in the aforementioned standardized format. In addition, some parameters must be stipulated and/or determined (e.g. by means of calibration), such as the position and orientation of the navigation sensor 125 in the robot.

In addition to the sensor for capturing the environment, further sensors essential for the navigation may be closely linked to the navigation unit, and the signals thereof are evaluated directly by the navigation unit. An example of this is an inertial measurement unit (IMU) for determining accelerations and angular velocities. This information can be used in order to determine the consistency of the odometry information obtained by the control unit and thus to improve the position determination of the robot in the map. In particular, the IMU can be used to detect accelerations deviating from the planned movement such as, for example, those which result from spinning of the wheels. In addition, the position of the robot can be determined relative to the gravitational acceleration. This information can be used for interpreting the environment information and determining the measuring direction of the navigation sensor.

The navigation unit 140 may function, for example, with an obstacle avoidance strategy (sense and avoid strategy) and/or a SLAM algorithm (Simultaneous Localization and Mapping), and/or with one or more maps of the robot's operational area. The robot can newly create such a map or maps of the robot's operational area when in use, or the robot can use a map already available at the start of use. An existing map can have been created by the robot itself during a previous use, for example a reconnaissance trip, or created by another robot and/or person. The navigation and task planning of the navigation unit 140 comprises, for example, the creating of target points, the planning of a path between the target points, and the determining of the activity of the operating unit 160 on the way to the target or at the target. In addition, the navigation unit 140 may manage a calendar (scheduler), in which previously planned activities are entered. Thus, a user can make an input, for example, that a cleaning robot starts cleaning daily at a fixed time.

As shown in the exemplary embodiment from FIG. 2, the system and communication unit 130, the navigation unit 140, and the control unit 150 are configured such that an exchange of information takes place only between the communication unit 130 and the navigation unit 140 as well as between the navigation unit 140 and the control unit 150. This is particularly expedient when fast, data-intensive communication is processed via the communication unit 130. Furthermore, the dataflow is hereby simplified.

As will be explained in greater detail subsequently, the navigation unit 140 and the navigation sensor 125 are functionally independent of the control unit 150 which processes the sensors provided by the control sensors 120. The information/data exchanged between the navigation unit 140 and the control unit 150 are transferred in a defined format, which is independent of the sensor hardware used. If a different navigation unit 125 is to be used in a successor model of the robot 100, only the software (and possibly also a few hardware components) of the navigation unit 140 must be adapted to the new navigation sensor, whereas this change has no impact on the control unit 150. In a similar manner, only the software (particularly drivers and possibly also a few hardware components) of the control unit 150 must be adapted when other or additional control sensors 120 or a different drive unit 170 or a different operating unit 160 are to be used in a successor model of the robot 100. The navigation unit 140 and the navigation sensor 125 used are thus functionally completely decoupled from the control unit 150 and the hardware (control sensors 120, operating unit 160, drive unit 170) connected to the control unit. As mentioned, both the control unit 150 and the navigation unit 140 may be at least partially implemented by means of software, which can be executed, however, independently on various processors (computing units) or processor cores. Furthermore, separate storage components or separate (e.g. protected) storage areas of a storage device may be assigned to the various processors or processor cores such that the software of the control unit 150 and the software of the navigation unit 140 can be executed independently of one another.

A chronological assignment is not readily possible due to the separate processing of sensor information and other events (e.g. user input) by means of the control unit 150 and the navigation unit 140. In order to simplify data processing and thus the navigation, the path planning, and task planning, a timestamp can be assigned to each measurement and each detected event. This timestamp should be clearly interpretable at least by the navigation unit 140. To this end, it is necessary that both the control unit 150 and the navigation unit use synchronous clocks via a clock generator 145. The clock generator may be a system clock, which generates a time signal, for example, at regular intervals, which time signal is received by both the navigation unit 140 and by the control unit 150. Alternatively, clock generators may be used in the computing units of the navigation unit 140 or the control unit 150.

For example, a clock generator may be used in the navigation unit 140. The navigation unit 140 establishes the timestamp to be assigned internally based on this clock. The clock generator 145 sends a clock signal to the control unit 150 at periodic intervals (e.g. each second). This clock signal is used to keep an internal clock generator of the control unit 150 synchronous with the clock generator used in the navigation unit. The control unit 150 can hereby assign the sensor information and other detected events with a timestamp which is synchronous with the timestamp of the navigation unit 140. For example, the control unit 150 determines odometry information based on measurements of an odometer. They are then provided with a timestamp and sent to the navigation unit 140. The navigation unit 140 obtains sensor information of the navigation sensor (particularly navigation features) which is likewise provided with a timestamp. Based on the timestamps, the navigation unit 140 can then decide whether it has already obtained the necessary odometry information and, if necessary, wait until new odometry information is received. Based on the timestamps, the measurements can be chronologically ordered and combined within the scope of a SLAM algorithm, whereby the status of the map and the pose of the robot are updated in this map.

Furthermore, the autonomous mobile robot 100 may have an energy supply such as, for example, a battery (not shown in FIG. 2). The battery can be charged, for example, when the autonomous mobile robot 100 is docked with a base station (not shown in the figures). The base station may be connected, for example, to the power grid. The autonomous mobile robot 100 may be designed to approach the base station autonomously when it is necessary to charge the battery or when the robot 100 has completed its tasks.

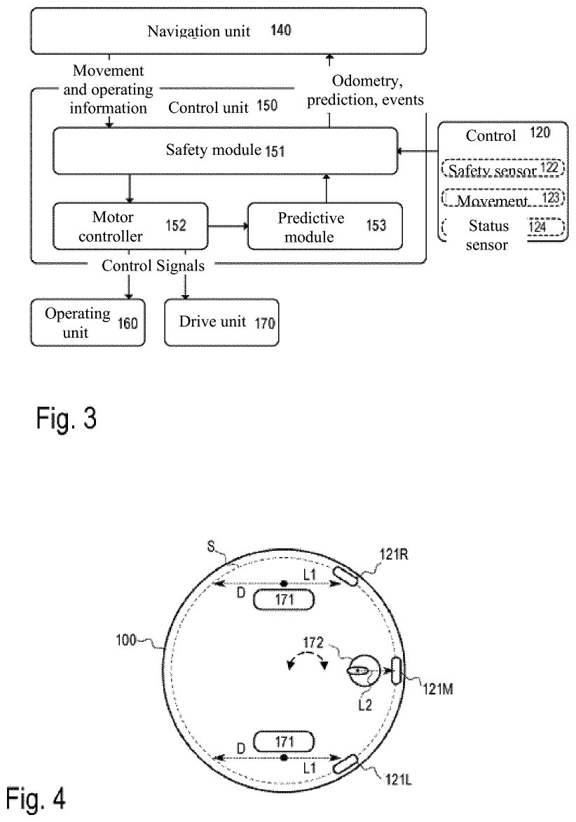

FIG. 3 shows an exemplary embodiment of the control unit 150 in greater detail. It may have, for example, a safety module 151, a motor controller 152, and a predictive module. The motor controller 152 is configured to generate specific signals to actuate the motors and actuators of the drive unit 170 and the operating unit 160 from the movement and task information obtained by the navigation unit 140. To this end, a buffer may be established which caches the control signals for a definable time span. The movement information in this case may contain an immediate stop of the robot, in which all control signals contained in the buffer are deleted and can be replaced with active deceleration control signals. For the control, information regarding the current and voltage measurement (status sensors 124) and also encoder information (movement sensor 123) can be used in a close-loop control.

During generation of the control signals, hardware-specific adaptations may be necessary which lead to a certain amount of deviations between the actually controlled movement and the movement originally planned by the navigation unit 140. Limitations (minimum curve radius, maximum acceleration, limited accuracy of the actuation, etc.) of the drive components (motors, power drivers, etc.) used in the drive unit 170 may lead to such deviations. For this reason, a predictive module 153 based on the buffer of the control signals can determine a future movement of the robot. In this case, a computation model can be used which can consider the inertia of the robot, the properties of the driver electronics, and/or the specific design of the drive unit (such as, for example, the position and size of the wheels). The result, for example, is a change in location and orientation in one or more pre-definable time intervals. This prediction can be transmitted to the navigation unit 140 so that it can be considered in the navigation and task planning.

The safety module 151 is designed to monitor selected safety-relevant aspects of the autonomous movement of the robot 100 autonomously and independently of the navigation unit 140. The safety module 151 is furthermore designed to intervene when the navigation unit 140 does not react in a hazardous situation or does not react appropriately. An inappropriate reaction is a reaction which does not prevent the hazardous situation or which could lead to another hazardous situation. An inappropriate situation may be, for example, a reaction which results in the robot 100 tipping or falling over, whereby further operation of the robot 100 is no longer possible without human intervention; or damage to the robot, damage to objects in the environment, damage to the floor covering, or injury to people in the area may result. In this regard, the safety module 151 can “filter,” i.e. reject or modify, the movement of the robot planned by the navigation unit 140.

In order to achieve the aforementioned functional independence of the control unit 150 from the navigation unit 140, the control unit 150 with the safety module 151 may have, as mentioned, its own processor as well as a storage module. Software to detect hazards can be stored in the storage module, which software can be executed by the processor. However, it is also possible that the control unit 150 with the safety module 151 shares a processor and/or a storage module with one or more of the other units of the robot 100. In one exemplary embodiment, a processor core of a multicore processor may be assigned to the control unit 150 with the safety module 151, with it being possible for the other processor cores thereof to be used by other units of the robot 100 (e.g. by the navigation unit 140). Nevertheless, the software of the safety module 150 can work functionally independently of the software of the control module 140 or other modules. If the control unit 150 has its own processor and its own storage module (or exclusively uses a processor core of a multicore processor), this can reduce interferences such that it is easier to ensure that the safety-relevant safety module 151 of the control unit 150 can react reliably and in a timely manner. In contrast with the navigation module 140 which does not necessarily obtain the information of the control sensors 120 in real time, the sensor information of the control sensors 120 is available to the control unit 150 and thus to the safety module 150 in real time, and therefore hazardous situations can be detected and reacted to quickly and reliably.

The software of the safety module 151 for detecting hazards in this case may be designed as simply as possible in order to ensure a reproducible and thus verifiably reliable detection of hazardous situations and reaction in hazardous situations. According to one exemplary embodiment, it is also possible that the control unit 150 of the autonomous mobile robot 100 has several safety modules 151, in which each of the safety modules 151 with its corresponding hazard-detection software is designed for a particular hazardous situation (e.g. the hazard of an immediately impending drop-off over a step) and is specialized for this.

One option for achieving the goal of simplicity of the safety module 151 as well as the hazard-detection software (and thus to enable a simple validation of the function of the safety module) is to use, for example, various designs of reactive and/or behavior-based robotics in the safety module 151. With such designs, the behavior of the robot 100 is determined, for example, only based on current sensor data. In contrast to such designs, the safety module 151 is designed, however, only to intervene in the planned movement of the robot 100 in exceptional situations, e.g. when an immediate hazard is detected and the navigation unit 140 cannot react appropriately. To this end, the safety module 151 may obtain the movement and task information and also the prediction of the future movement of the predictive module 153 from the navigation unit 140. If the movement information leads to a safe movement, it is transferred to the motor controller 152. In the event of an unsafe movement, the movement information can be changed or rejected by the safety module 151 before it is transferred to the motor controller 152. Additionally or alternatively, the safety module 151 may send a command for an “emergency stop” to the motor controller 152. This means that all control signals stored in the buffer are rejected, and new signals are generated for active deceleration (and possibly resetting) of the robot 100. To this end, the safety module 151 may be designed to detect forbidden or potentially hazardous movement information (which has been received by the navigation unit 140) based on the current information supplied by the control sensors 120, which information could lead to an accident without the intervention of the safety module 151. Alternatively, the safety module 151 can also actuate the drive unit directly, thus bypassing the motor controller 152, in order to slow the movement of the robot. Furthermore, the safety module 151 can also interrupt the supply of current to the drive unit or to the motors contained therein.

For example, the safety module 151 may be coupled to one or to several floor clearance sensors as safety sensors 122. When a floor clearance sensor displays an unusually great distance to the floor (e.g. because the robot is going to travel over an edge shortly or because the robot is lifted up), the safety module 151 can evaluate the situation as a hazardous situation. When the floor clearance sensor in question is arranged at the front on the robot (as viewed in the direction of travel), the safety module 151 can classify the current movement as being potentially hazardous and initiate a stop of the current movement or change the movement (e.g. reverse travel). In this case, the criterion that the safety module 151 uses to a detect hazardous situation and the criterion that the safety module 151 uses to evaluate the current movement (as being hazardous or nonhazardous) are practically the same. If a drop-off sensor positioned in front in the direction of travel displays an increased distance, a hazardous situation is detected, and the current movement is evaluated as hazardous; the safety module rejects the forward movement planned by the navigation unit 140 and stops the current movement. Thus, the safety module can immediately stop the current movement of the robot upon the detection of certain hazardous situations (e.g. when a pending drop-off over an edge is detected) (because practically any continuation of the current movement is classified as being inappropriate/hazardous).

The information issued by the control sensors 120 can be evaluated in order to evaluate the movement information sent by the navigation unit 140. For example, the information of the control sensors 120 may relate to the internal status (status sensors 124) and/or the environment (safety sensors 122) of the robot 100. The information may thus be, for example, information on the environment of the robot 100, e.g. the position of drop-off edges, thresholds, or obstacles, or a movement of obstacles (e.g. people). The information received regarding the environment of the robot 100 may be linked to information regarding a current movement (movement sensor 123) or planned movements (predictive module 153) of the robot 100 by the safety module 150. In this case, information can either be processed directly after receipt in the safety module 151 and/or initially stored there for a definable timeframe or a definable distance (distance traveled by the robot 100) before it is processed and/or considered.

In addition, the information received may also relate to map data of the environment of the robot 100, which is created and managed, for example, by the navigation unit 140. For example, information regarding drop-off edges or other obstacles may be contained in the map data. During normal operation, the robot 100 “knows” where it is situated on the map at the current point in time.

By means of the information received, the safety module 150 can check whether there is a hazardous situation at hand. A hazardous situation is considered to be present, for example, when a drop-off edge, a terrain that is unfavorable for the robot 100 (e.g. wet, slick, strongly inclined, or uneven ground), or there is an obstacle in the direct environment of the robot 100 or moving towards it (e.g. people). If no hazardous situation is detected, nothing happens, and the safety module 151 transfers the movement information to the motor controller 152 unchanged.

If the safety module 151 detects a hazardous situation, it can firstly inform the control module 140 of this. For example, information regarding a detected drop-off edge or a pending collision can be sent to the navigation unit 140. However, it is not absolutely necessary to inform the navigation unit 140 of the detected hazardous situation. The safety module 151 can also function as a “silent observer” and check the hazardous situation without informing the navigation unit 140 about this. In this case, only the sensor information (e.g. odometry information with timestamp) would be transferred, as previously described. Furthermore, the safety module 151 can check whether the navigation unit 140 is reacting correctly to the detected hazardous situation. This means that the safety module 151 can check whether the movement information of the navigation unit 140 is guiding the robot 100 toward an obstacle (or a drop-off edge, etc.) (and thus making the hazardous situation worse), or is guiding the robot 100 away from the hazardous situation, decelerating it, or stopping it. To this end, the safety module 151 can initially determine, depending on the detected hazardous situation, which movements could lead essentially to an accident of the robot 100. A movement which has a high probability of leading to an accident can be classified, for example, as a “hazardous movement,” while movements which have a high probability of not leading to an accident can be classified as “safe movements.” A hazardous movement, for example, is a movement in which the robot 100 moves directly to a drop-off edge or an obstacle (or does not move away from a drop-off edge or obstacle). Movements in which the robot 100 could brush up against an obstacle and thereby cause itself to sway, fall over, or tip over, or if the obstacle could be damaged by the contact, can be classified as hazardous.

According to the classification of the movements as safe or hazardous, the safety module 151 can then check whether the current movement of the robot 100 represents a hazardous movement or a safe movement. In this case, the safety module 150 can check, for example, whether the robot 100 is continuing to move toward the hazardous situation or whether it possibly is passing by the obstacle or changing direction and moving away from the hazardous situation. The safety module 151 can use and analyze, for example, the prediction of the predictive module 153, the odometry information (movement sensor 123), and/or the movement information which is sent by the navigation unit 140. If the safety module detects that the robot 100 is executing a movement classified as hazardous, it can initiate countermeasures (safety measures) which ensure the safety of the robot 100 as well as objects in the vicinity, thus preventing the accident or at least mitigating it. Countermeasures may be, for example, the rejecting or changing of movement information of the navigation unit 140. Control signals of the safety module 150 may have, for example, directional and/or speed commands which prompt the robot 100, for example, to change its direction and/or its speed. Accidents can be prevented, for example, merely by reducing the speed if a moving object crosses the intended path of the robot. In many cases, it may be sufficient, for example, if the robot 100 only changes its direction slightly or even strongly without the speed being changed. It is likewise conceivable that the robot 100 moves in the completely opposite direction, that is, for example, executes a 180° turn or travels in reverse. An accident can usually be reliably prevented by stopping (emergency stop) the robot 100.

If the safety module 151 rejects or modifies the movement information of the navigation unite, it is (optionally) possible, as mentioned, that the safety module 151 informs the control unit 140 of the countermeasures. The navigation unit 140 can confirm the receipt of this information. A confirmation can take place, for example, in that the navigation unit 140 issues changed movement information which is adapted to the detected hazardous situation. However, it is also possible that the navigation unit 140 issues a confirmation directly to the safety module 151.

If no response or no valid response of the navigation unit 140 takes place within a pre-defined time (e.g. 1 second), the safety module 151 can assume, for example, that safe operation of the robot 100 can no longer be ensured. In this case, the robot 100 can optionally be stopped for a sustained amount of time. A restart is then only possible, for example, when it is released actively by a user or the robot 100 has been maintained by the user or a technician (e.g. cleaning of sensors).

According to one embodiment of the invention, the navigation unit 140 can send a request to the safety module 151 which means that a movement classified as hazardous by the safety module 151 can still be executed in order to enable further operation of the robot 100. The request can be presented after the navigation unit 140 has been informed by the safety module 151 of the countermeasures to a hazardous movement. Alternatively or additionally, the request can be presented as a precaution such that the safety module 151 is informed in advance of the planned movement. An interruption of the planned movement, for example, can hereby be avoided. The safety module 151 can verify this request and inform the navigation unit 140, in turn, whether the requested movement will be permitted.

With many robots, the sensors of the robot (particularly safety sensors 122) are only designed for forward movement of the robot 100, i.e. measuring direction in the usual direction of travel, thus in the region in front of the robot 100. This means that they cannot provide any information or only very limited information regarding the region behind the robot 100. Reverse travel of the robot 100 can thus only be classified as safe, for example, over very short distances, e.g. reverse travel over a distance of less than 5 cm or less than 10 cm. Longer distances of reverse travel can thus not be permitted, for example, by the safety module 151. However, longer distances of reverse travel may be necessary, for example, during an approach to a base station or during an exit from a base station, at which the robot 100 can charge its energy supply. Normally, the safety module 151 can assume in this case that the base station has been placed properly by the user such that a secure approach to and exit from the base station is possible. If the robot 100 then must exit or approach the base station, and a longer distance of reverse travel is necessary for this, the navigation unit 140 can send a corresponding request to the safety module 151. The safety module 151 can then check, for example, whether the robot 100 is actually positioned at the base station. To this end, there can be a check, for example, as to whether a voltage is present at the corresponding charging contacts of the robot 100. The charging contacts in this case form a type of status sensor 124 which can detect whether the robot has docked with the charging station. Another option, for example, is that a contact switch is closed upon docking with the base station. The safety module 151 can thus check whether the contact switch is closed. These are just examples, however. Another suitable type and manner of checking can be used to determine whether the robot 100 is located at the base station. When the safety module 151 detects that the robot 100 is at a base station, it can release the path required for exiting the base station for reverse travel, even though the required distance exceeds the normally permissible distance of reverse travel. However, if the safety module 151 detects that the robot 100 is not situated at a base station, only the normally permitted path of reverse travel can be released. However, this is merely an example. There are various other situations conceivable in which the safety module 151 considers a movement classified as hazardous as being safe by exception and releases it.

According to a further embodiment of the invention, the control unit 150 and particularly the safety module 151 is designed to carry out a self-test. In this case, the self-test may include, for example, a read and write test of the storage module which is part of the safety module 151. If such a self-test fails, the robot 100 can be stopped and switched off for a sustained amount of time until operation of the robot 100 is again released by a user. After failure of a self-test, safe operation of the robot 100 can normally not be ensured. A self-test can be achieved, for example, as well by a redundant design of various components. Thus, the processor and/or the storage module of the safety module 151, for example, may be present in duplicate, in which case hazard-detection software can be run on both existing processors. As long as the result of both processors is identical or only has slight deviations, it can be assumed that the safety module 151 is functioning properly.

According to a further embodiment of the invention, the safety module 151 can be designed to monitor the reliable operation of the control sensors 120. In this case, it may be sufficient to only monitor those sensors that supply safety-relevant information. Due to this monitoring of the sensors, it can be detected whether a sensor is supplying incorrect or unreliable data, for example, due to a defect or dirt. In this case, the sensors to be monitored may be designed to independently detect malfunctions and to report them to the safety module 151. Alternatively or additionally, the sensors may be designed to then only supply suitable measurement data as long as the sensor is fully functional. Thus, a floor clearance sensor, for example, cannot be detected as functional if it continually supplies a distance to the ground of zero (or infinity) instead of a value typical for the distance from the sensor to the floor. Alternatively or additionally, the safety module 151 can also verify the data received by the sensors for consistency. For example, the safety module 151 can check whether the sensor data, which are used to determine the movement of the robot 100 (movement sensor 123, particularly wheel encoder), are consistent with the measured power consumption (status sensor 124, ammeter and voltmeter) of the drive unit. If one or more faulty sensor signals is detected, the robot can be stopped and switched off for a sustained amount of time until the user again releases operation, because, otherwise, safe operation of the robot 100 can no longer be ensured.

Essentially, any known hazardous situation can be detected with the described method. The known hazardous situations in this case can be precisely simulated in test situations in order to verify the safety of the robot 100. With such a test, the robot 100 can be precisely placed, for example, into a potential hazardous situation (e.g. positioning of the robot in the vicinity of a drop-off edge). A case can then be simulated in which the navigation unit 140 sends incorrect and/or random movement information to the control unit 150. Subsequently, it is possible to observe whether the safety module 151 can reliably prevent an accident. To this end, the navigation unit 140 can enable a specialized test mode, in which pre-defined movement patterns are created and/or the movement information is definable via the communication unit 130 (e.g. remote control).

FIG. 4 illustrates, by means of example, a top view of a lower side of an autonomous mobile robot 100. FIG. 4 in this case shows, by means of example, a cleaning robot, in which the cleaning module of the robot is not shown for the sake of simplicity. The robot 100 shown has two drive wheels 171 (differential drive), which are part of the drive module 170, and a front wheel 172. For example, the front wheel 172 may be a passive wheel, which has no drive itself and which only moves over the floor due to the movement of the robot 100. The front wheel 172 in this case may be rotatable 360° about an axis, which is essentially perpendicular to the floor (the direction of rotation is indicated in FIG. 4 by a dotted-line arrow). The drive wheels 171 can each be connected to an electric drive (e.g. electric motor). The robot 100 moves forward due to the rotation of the drive wheels 171. The robot 100 further has floor clearance sensors 121 (as a part of the safety sensors 122). In the example shown in FIG. 4, the robot 100 has three floor clearance sensors 121R, 121M, 121L. A first floor clearance sensor 121R is situated, for example, on the right-hand side of the robot 100 (as seen in the direction of travel). In this case, the first floor clearance sensor 121R does not have to be arranged on the center axis x, which divides the robot 100 evenly into a front part and a rear part. The first floor clearance sensor 121R may be arranged, for example, toward the front, as viewed easily from the center axis x. A second floor clearance sensor 121L is situated, for example, on the left-hand side of the robot 100 (as seen in the direction of travel). In this case, the second floor clearance sensor 121L likewise does not have to be arranged on the center axis x. The second floor clearance sensor 121L may likewise be arranged, for example, toward the front, as viewed easily from the center axis x. A third floor clearance sensor 121M may be arranged, for example, at the center front on the robot 100. For example, at least one floor clearance sensor 121 is arranged in front of each wheel such that a drop-off edge is detected during forward travel, before the wheel travels over it.

The floor clearance sensors 121 are designed to detect the distance between the robot 100 and the ground or are at least designed to detect whether a surface area is present in a certain distance interval. During normal operation of the robot 100, the floor clearance sensors 121 normally provide relatively uniform values, because the distance between the floor clearance sensors 121 and thus the robot 100 and the ground only changes slightly. Particularly with smooth floors, the distance to the ground is usually largely the same. There may be slight deviations in the values, for example, on carpets, on which the drive wheels 171 and the front wheel 172 can sink down. The distance between the robot body with the floor clearance sensors 121 and the ground can thereby be reduced. Drop-off edges, such as e.g. stairsteps, can be detected, for example, when the values supplied by at least one of the floor clearance sensors 121 suddenly increases greatly. For example, a drop-off edge can be detected when the value measured by at least one floor clearance sensor 121 increases by more than a predefined limit value. The floor clearance sensors 121 may have, for example, a transmitter for an optical or acoustic signal as well as a receiver, which is designed to detect the reflection of the sent signal. Potential measuring methods include measuring the intensity of the signal reflected by the floor, triangulation, or measuring the runtime of the sent signal and the reflection thereof. According to one embodiment of the invention, a floor clearance sensor 121 does not determine, for example, the precise distance between the sensor and the ground, but rather only supplies a Boolean signal, which indicates whether the ground is being detected within a pre-defined distance (e.g. ground detected at a distance of no more than 5 cm away from the sensor 121, for example). The specific evaluation and interpretation of the sensor signals can take place in the control unit 150.

Typical movements executed by an autonomous mobile robot (or the movements planned by the navigation unit 140, which are sent in the form of movement information to the control unit 140) include a forward movement, a rotational movement to the right or to the left, and combinations of these movements. If the robot 100 moves toward a drop-off edge during the execution of such a movement, this is detected at least by one of the floor clearance sensors 121. Those particular movements which could lead to an accident (a crash in this case) of the robot 100 can thereby be determined from simple geometrical considerations. For example, if the first or the second floor clearance sensor 121R, 121L is triggered, with both being arranged on the side of the robot 100, then the robot 100 can subsequently only move forward a maximum of a first distance L1, in which the first distance L1 corresponds to the distance between the corresponding drive wheel 171 (wheel contact point) and the floor clearance sensor 121R, 121L. If the third floor clearance sensor 121M, for example, is triggered, which is situated at the front on the robot 100, then the robot 100 can subsequently only move forward a maximum of a second distance L2, in which the second distance corresponds to the distance between the front wheel 172 (wheel contact point) and the third floor clearance sensor 121M. Thus, when traveling at full speed, the robot 100 must be capable of detecting a drop-off edge, generating a control signal for deceleration, and coming to a stop before reaching the drop-off edge (i.e. within the first and/or second distance L1, L2). In this case, consideration should be given particularly to the reaction times of the individual required components, e.g. of the relevant safety sensor 122, of the navigation unit 140, of the control unit with the safety module 151, and of the motor controller and the drive unit 170, as well as the speed of the robot 100, the potential (negative) acceleration until deceleration of the robot 100 (inertia), and the deceleration path associated herewith. For example, the safety module 150 may be designed to only permit reverse movement of the robot 100 as long as at least one of the floor clearance sensors 121 is triggered. A floor clearance sensor is triggered when it is detected that the floor clearance is greater than a permissible maximum value.

In the example shown in FIG. 4, the second distance L2 is shorter than the first distance L1. In order to ensure that the robot 100 is still stopped in time before a drop-off edge after triggering of the third floor clearance sensor 121M, the safety module 151 may be designed, for example, to reject all movement information of the navigation unit 140, and to prompt the motor controller to generate a control signal for the immediate stopping of the robot 100, as soon as the third floor clearance sensor 121M has been triggered. The safety module 151, for example, cannot check the correct behavior of the navigation unit 140, because this could take up too much time. Only after the stopping of the robot 100 can the safety module 151 check, for example, whether the navigation unit 140 is likewise sending movement information appropriate for the situation. Appropriate movement information in such a situation may include, for example, commands to stop the robot, to travel in reverse, or to implement a turn away from the drop-off edge. Such movement information would be sent from the safety module 151 to the motor controller without objection. However, if the safety module 151 detects that movement information to carry out a hazardous movement (e.g. forward travel) is being generated by the navigation unit, then the safety module can retain or take over control of the robot in that this movement information is rejected.

In the event of triggering of the first or of the second floor clearance sensor 121R, 121L, it may be sufficient, for example, to wait for a reaction from the navigation unit 140 to the hazardous situation, because more time is available until the robot 100 must come to a stop in order to prevent an accident. In such a case, the safety module 151 can wait, for example, until the robot 100 has traveled a third distance L3 (e.g. where L3=L1−L2). At this point in time, the robot 100 only has time available for the second distance L2 in order to prevent an accident. During the time required for the third distance L3, the safety module 151 can thus still allow the navigation unit 140 to continue without rejecting its movement information and/or stopping the robot 100. If the navigation unit 140 reacts appropriately during this time (movement information which guides the robot 100 away from the detected drop-off edge), the safety module 151 does not have to intervene, and it remains passive (passes on the unchanged movement information). A determination can be made as to whether the third distance L3 has already been traveled, for example, on the basis of the potential maximum speed of the robot 100, with the aid of the time elapsed and/or with the aid of odometers. The safety module 151 can stop the robot 100, for example, if the navigation unit 140 does not stop the robot 100 and/or move it away from the drop-off edge within 10 ms after the detection of a drop-off edge by the first or second floor clearance sensor 121R, 121L. The prediction of the movement from the predictive module 153 can be used in the determination of distance L3 and when this distance was traveled.

For cost reasons, robots 100 frequently only have floor clearance sensors in the front region of the robot 100, as shown in FIG. 4, such that drop-off edges can only be detected during forward travel of the robot 100. Because the robot 100 predominantly continues to move in the forward direction, this is normally sufficient to ensure safe operation of the robot 100 with respect to drop-off edges. In some situations however, a movement in the forward direction may be blocked by obstacles or drop-off edges. In such situations, it may be unavoidable that the robot 100, as a whole or at least with one of its drive wheels 171, travels in reverse in order to free itself from this situation. The robot 100 in this case can only travel safely in reverse as far as it knows its way in this direction. If it does not know the way, there is the risk of an accident due to the lack of floor clearance sensors in the rear part of the robot 100, because the robot cannot detect, for example, drop-off edges located behind it. The distance most recently traveled by the robot 100 can be approximated, for example, as a straight line. Reverse travel can be detected as safe, for example, for a fourth distance D, where D is the distance between the drive wheels 171 and the circumference S, on which the floor clearance sensors 121 are arranged in the front region of the robot 100. Once the robot has most recently traveled forward a distance which is less than the fourth distance D, it can move in reverse over a distance which is no greater than the distance most recently traveled in the forward direction. With combined forward and reverse movements, the distance actually traveled can be determined (e.g. with the movement sensor 123) and considered for any necessary reverse travel.

The safety module 151 may be designed, for example, to not allow any reverse movement directly after switch-on of the robot 100, because the robot might not have any information regarding its environment at hand and possibly may not know whether there is a drop-off edge behind it. For example, the robot 100 may have been placed on a table close to the table edge, or on a stairstep, or stairway landing by a user. In this case, the safety module 151 can also then block a reverse movement of the robot 100, for example, when the forward direction is blocked by an obstacle or a drop-off edge. As previously described above, the control unit 140 can send, for example, a corresponding request to the safety module 151 when it wishes to control the robot 100 movement in reverse away from a base station. Upon such a request, once the safety module 151 verifies that the robot 100 is actually situated on the base station, it can release the distance required to move away from the base station for reverse travel.

The movement of the robot 100 can be determined by means of the most varied of sensors, for example by means of odometers (e.g. wheel encoders) and/or calculated based on the control signals from the predictive module 153. In this case, the distance traveled, for example, by the robot 100 can be stored in a predetermined time interval and/or movement interval. In addition, the position and/or path of the floor clearance sensors 121 can be stored in order to better estimate a safe surface.

According to one embodiment of the invention, the circumference S, on which the floor clearance sensors 121 are arranged, can be considered a surface safe for travel when the robot 100 has previously traveled forward a distance which is at least greater than the radius of the circumference S. In this case, the safety module 151 may be designed to stop the robot 100 when it detects (e.g. on the basis of the control commands and/or an odometer measurement) that the robot 100 has exited the circumference S due to a rearward-directed movement during reverse travel (and short forward movements combined therewith).

In order to prevent collisions, several sensors may be used jointly to detect obstacles. For example, the safety sensors 122 comprise optical sensors (e.g. infrared sensors with a measuring principal similar to that of the floor clearance sensors), which are designed to detect, without contact, obstacles in close vicinity of the robot. The safety sensors 122 may also comprise, for example, tactile sensors, which are designed to detect, upon contact, obstacles which are optically difficult to detect (e.g. glass doors). A tactile sensor may have, for example, a contact switch, which is designed to close when there is contact with an object. A tactile sensor may further have, for example, a spring deflection which enables the robot 102 to decelerate before the main body of the robot 100 impacts the obstacle. In such a case, the safety module 151 behaves similarly to the behavior upon the triggering of a floor clearance sensor 121 upon detection of a drop-off edge.

The safety module 151 may be designed, for example, to monitor obstacles in the vicinity of the robot. If obstacles are detected within a predefined distance to the robot 100, the safety module 150, for example, can prevent movements at a speed greater than a limit speed. The predefined distance may be dependent on the direction in which the obstacle is detected. For example, an obstacle detected behind the robot 100 normally does not limit the forward movement of the robot 100. The limit speed may be dependent on the distance away from the obstacle and/or on the direction in which the obstacle is detected.

The safety module 151 may also be designed to prevent speeds and/or accelerations which are greater than a predefined limit value when an object (people, house pets) situated in the environment of the robot is detected by means of a suitable safety sensor 122 (e.g. thermal imaging), regardless of the speed at which and the direction in which the object moves. The limiting of the maximum speed increases the time, for example, that the robot 100 has available to react to unexpected movements of the object. At the same time, a limit of the maximum speed reduces the risk of injuries to people or animals and damage to the robot or objects, because the reduction in speed leads to a reduction in the kinetic energy of the robot 100. By limiting the acceleration of the robot 100, people in the environment can better estimate the behavior of the robot 100 and can more easily react to movements of the robot, whereby the risk of accidents is likewise reduced.

The status sensors 124 of an autonomous mobile robot 100, for example a transport robot, may comprise, for example, sensors which are designed to detect whether and what objects (e.g. glasses or plates) the robot 100 is transporting. By means of this information, the movements of the robot can be adapted and limited. For example, a robot 100 can accelerate more quickly and continue to move at a greater speed when it is not transporting. If the robot is transporting, for example, flat objects such as plates, it can normally accelerate more quickly than it can when glasses or bottles are being transported.

The safety module 151 may further be designed to monitor a function of the operating module 160. This may be particularly advantageous when the activity of the operating module 160 is associated with a greater movement of the operating module 160 itself and/or a movement of the robot 100 by means of the drive module 170.

The operating module 160 may have, for example, a brush for collecting dirt. In this case, there is basically the risk that the rotating brush winds up, for example, shoelaces from shoes lying around, the fringes of rugs/carpet, or cables from electrical devices and thereby becomes blocked. The rotation of the brush can be measured, for example, by means of a speed encoder. A blocked brush can then be detected when no more rotation of the brush can be detected. It is also possible, for example, to determine the power consumption of the brush motor and to thereby detect a blocked brush.

There are various methods known for freeing a blocked brush. For example, the brush can be switched into idle mode and the robot 100 can execute a reverse movement, in which the cable, etc., is then unwound. However, this procedure has risks. Movements of the robot 100 when the brush is blocked can essentially lead to accidents. For example, if the cable wound up on the brush is the cable from an electrical device, there is essentially the risk that the robot will pull the electrical device along with it when moving in reverse. If the electrical device is in a raised position, for example arranged on a shelf, the device can thereby fall to the floor and become damaged. Thus, the safety module 151 may be designed, for example, to detect whether the brush is still blocked once a method for freeing the brush has been implemented. The movement of the robot 100 in such a case can be stopped, for example, because neither a forward nor a reverse movement is possible without damaging objects. A further option is to rotate the brush in a direction opposite the normal direction of movement in order to free the cable, etc., from the brush without the robot 100 changing its position in this case.

1. An autonomous mobile robot, comprising:
a drive unit which is designed to receive control signals and to move the robot in accordance with the control signals;
a navigation sensor for capturing navigation features;
a navigation unit coupled to the navigation sensor, which navigation unit is designed to receive information from the navigation sensor and to plan a movement for the robot;
a control unit, which is designed to receive movement information representing the movement planned by the navigation unit and to generate the control signals based on the movement information;
further sensors which are coupled to the control unit, wherein the control unit receives further sensor information from the further sensors, pre-processes the further sensor information, and supplies the pre-processed sensor information in a pre-defined format to the navigation unit; and
wherein the planning of the movement for the robot by the navigation unit is based both on the information from the navigation sensor and on the pre-processed sensor information supplied by the control unit.

2. The autonomous mobile robot according to claim 1,
wherein the navigation unit and the control unit are functionally independent and the pre-defined format for the pre-processed sensor information is independent of implementation of the further sensors.

3. The autonomous mobile robot according to claim 1,
wherein both the control unit and the navigation unit each have a clock generator, with the clock generators being synchronized, and
wherein the pre-defined format for the pre-processed sensor information comprises a timestamp assigned to the pre-processed sensor information and/or wherein the movement information provided by the navigation unit comprises a timestamp, which is assigned to a planned movement.

4. The autonomous mobile robot according to any of claim 1,
wherein both the control unit and the navigation unit are implemented, at least partially, by software, which is executed in different processors or processor cores.

5. The autonomous mobile robot according to any of claim 1,
wherein the navigation unit has a first computing unit, to which a first storage device or storage area is assigned, and the control unit has a second computing unit to which a second storage device or storage area is assigned,
wherein the first computing unit is designed to execute navigation software which uses a map of an environment of the robot.

6. The autonomous mobile robot according to claim 5,
wherein the navigation software, when executed on the first computing unit, causes the navigation unit to create a map of the environment of the robot based on the information received from the navigation sensor and determines a position and orientation of the robot on the map.

7. The autonomous mobile robot according to claim 1,
wherein the navigation unit has an interface to a communication unit, which enables communication with external devices, particularly for providing map information and status information of the robot.

8. The autonomous mobile robot according to claim 7,
wherein the navigation unit is designed to implement the planning of the movement for the robot depending on commands which have been received via the communication unit.

9. The autonomous mobile robot according to claim 1,
wherein the further sensors comprise:
a safety sensor, which captures information regarding the direct environment of the robot, a movement sensor, which captures information regarding a current movement of the robot, a status sensor, which captures information regarding the status of the robot, or a combination thereof.

10. The autonomous mobile robot according to claim 10,
wherein the movement sensor is an odometry sensor, and
wherein the pre-processed sensor data contains information which depends on the sensor signals supplied by the odometry sensor.

11. The autonomous mobile robot according to claim 1,
wherein the control unit contains a safety module, which is designed to verify the movement information received by the navigation unit in order to determine, while considering the further sensor information, whether the planned movement will or could cause a hazardous situation.

12. A method for an autonomous mobile robot, which comprises:
planning a movement for the robot in a navigation unit of the robot based on information which is supplied by a navigation sensor, which captures navigation features;
transferring movement information representing the movement planned by the navigation unit to a control unit of the robot;
generating control signals for a drive unit of the robot based on the transferred movement information in the control unit;
receiving further sensor information from further sensors, pre-processing the further sensor information by means of the control unit, and providing the pre-processed sensor information in a pre-defined format;
transferring the pre-processed sensor information in the pre-defined format to the navigation unit,
wherein the planning of the movement for the robot by the navigation unit is based both on the information from the navigation sensor and on the pre-processed sensor information supplied by the control unit.
